(19) United States
(12) Patent Application Publication
(10) Pub. No.: US 2013/0030651 A1
(43) Pub. Date: Jan. 31, 2013

(54) COLLISION AVOIDANCE MANEUVER THROUGH DIFFERENTIAL BRAKING

(71) Applicants: Nikolai K. Moshchuk, Grosse Pointe, MI (US); Shih-Ken Chen, Troy, MI (US); Jin-Woo Lee, Rochester Hills, MI (US); Chad T. Zagorski, Clarkston, MI (US); Aamrapali Chatterjee, Okemos, MI (US)

(72) Inventors: Nikolai K. Moshchuk, Grosse Pointe, MI (US); Shih-Ken Chen, Troy, MI (US); Jin-Woo Lee, Rochester Hills, MI (US); Chad T. Zagorski, Clarkston, MI (US); Aamrapali Chatterjee, Okemos, MI (US)

(73) Assignee: GM GLOBAL TECHNOLOGY OPERATIONS LLC, Detroit, MI (US)

(21) Appl. No.: 13/190,111

(22) Filed: Jul. 25, 2011

(51) Int. Cl. G08G 1/16; B60T 8/1763; B62D 6/00

(52) U.S. Cl. 701/41

(57) ABSTRACT

A collision avoidance system in a host vehicle that provides automatic steering control using differential braking in the event that the normal steering control fails. The system determines whether a collision with an object, such as a target vehicle, in front of the host vehicle is imminent, and if so, determines an optimal path for the host vehicle to travel along to avoid the object if the collision is imminent. The collision avoidance system may determine that automatic steering is necessary to cause the vehicle to travel along the optimal path to avoid the target. If the collision avoidance system does determine that automatic steering is necessary and detects that normal vehicle steering has failed, the system uses differential braking to steer the vehicle along the path.

### BACKGROUND OF THE INVENTION

1. Field of the Invention

This invention relates generally to a system and method that provides enhanced collision avoidance for a vehicle and, more particularly, to a system and method that provides enhanced collision avoidance for a vehicle that employs differential braking to steer the vehicle in the event of a potential collision if a normal steering failure is detected.

2. Discussion of the Related Art

Collision avoidance systems and/or adaptive cruise control systems are known in the art that provide automatic vehicle control, such as braking, if a potential or imminent collision with another vehicle or object is detected, and also may provide a warning to allow the driver to take corrective measures to prevent the collision. For example, adaptive cruise control systems are known that employ a forward looking sensor, such as a radar or lidar sensor, that provides automatic speed control and/or braking if the vehicle is approaching another vehicle. Also, collision avoidance systems are known that employ sensors for determining if a collision with an object may be imminent that may provide automatic vehicle braking even if the vehicle operator is controlling the vehicle.

These types of systems typically employ long-range sensors that have a narrow field-of-view in the near-field of the vehicle. Particularly, the sensor signals emanate from a point source on the vehicle and extend in the forward direction of the vehicle, typically to about 150 meters. The collision warning system transmits a radar or laser beam forward of the vehicle and processes reflections from objects in the path of the vehicle. The system generates measurements from the reflections and assesses the potential for a collision based on the vehicle's speed, range and velocity relative to the objects, road surface conditions, etc. A driver alert of a potential collision can be a visual indication on the vehicles instrument panel or in a head-up display (HUD), and/or can be an audio warning or other haptic feedback device, such as seat shaking.

It has recently been proposed in the art to combine automatic braking and steering in an ECA system. For example, U.S. patent application Ser. No. 12/908,699, titled, Vehicle Collision Avoidance and Warning System, filed Oct. 20, 2010, assigned to the assignee of this application and herein incorporated by reference, discloses a system and method for providing collision avoidance that employs both combined automatic braking and steering.

The collision avoidance system disclosed in the '699 application defines first, second, third and fourth thresholds that identify a time to collision with a target vehicle by a host vehicle that are based on the speed of the host vehicle, the acceleration of the host vehicle, the speed of the target vehicle, the acceleration of the target vehicle, the distance to the target vehicle from the host vehicle and a coefficient of friction of the roadway on which the host vehicle and the target vehicle are traveling, where the first threshold is greater than the second threshold, the second threshold is greater than the third threshold and the third threshold is greater than the fourth threshold. The collision avoidance system determines if the time to collision is less than the first threshold, and if so, initiates a collision warning. The collision avoidance system also determines if the time to collision is less than the second threshold if the time to collision is less than the first threshold, and if so, provides limited automatic braking of the host vehicle.

The collision avoidance system disclosed in the '699 application also determines if the time to collision is less than the third threshold if the time to collision is less than the second threshold, and if so, check the condition of whether a roadway lane adjacent to the host vehicle is clear. The collision avoidance system provides full automatic collision avoidance braking if the time to collision is less than the third threshold and the lane adjacent to the host vehicle is not clear.

The collision avoidance system disclosed in the '699 application also determines if the time to collision is less than the fourth threshold if the time to collision is less than the third threshold and the lane adjacent to the host vehicle is clear. The collision avoidance system provides both automatic steering and braking of the host vehicle if the time to collision is less than the fourth threshold and the lane adjacent to the host vehicle is clear.

U.S. patent application Ser. No. 13/101,397, titled, Lane Centering Fail-Safe Control While Using Differential Braking, filed May 5, 2011, assigned to the Assignee of this application and herein incorporated by reference, discloses a lane centering system that provides automatic lane centering for a autonomous or semi-autonomous vehicle, where the vehicle control system employs differential braking to provide steering along a desired path to provide the lane centering if the system detects a failure with an automatic steering system on the vehicle.

### SUMMARY OF THE INVENTION

In accordance with the teachings of the present invention, a collision avoidance system in a host vehicle is disclosed that provides automatic vehicle direction control using differential braking in the event that the normal steering control fails. The system determines whether a collision with an object, such as a target vehicle, in front of the host vehicle is imminent, and if so, determines an optimal path for the host vehicle to travel along to avoid the object if the collision is imminent. The collision avoidance system may determine that automatic steering is necessary to cause the vehicle to travel along the optimal path to avoid the target. If the collision avoidance system does determine that automatic steering is necessary and detects that normal vehicle steering has failed, the system uses differential braking to steer the vehicle along the path.

Additional features of the present invention will become apparent from the following description and appended claims, taken in conjunction with the accompanying drawings.

### BRIEF DESCRIPTION OF THE DRAWINGS

FIG. 1 is a schematic illustration of a vehicle including an ECA system and a differential braking system;

FIG. 2 is an illustration of a host vehicle following a target vehicle on a roadway showing the host vehicle taking an evasive steering maneuver along an optimal path to prevent a collision with the target vehicle; and

FIG. 3 is a flow chart diagram showing a process for employing differential braking to provide steering control in a collision avoidance system.

### DETAILED DESCRIPTION OF THE EMBODIMENTS

The following discussion of the embodiments of the invention directed to an enhanced collision avoidance system that provides automatic steering control using differential braking in the event that normal steering control has failed is merely exemplary in nature, and is in no way intended to limit the invention or its applications or uses.

As will be discussed in detail below, the present invention proposes an enhanced collision avoidance (ECA) system for a host vehicle that provides combined automatic braking and steering if a collision with a target vehicle is imminent. Although the discussion herein concerns a potential collision of a host vehicle with a target vehicle, the ECA system being discussed has application for a potential collision with any object in front of the host vehicle. The ECA system will provide some type of warning to the driver of the host vehicle as a collision with the target vehicle becomes more probable, and if the driver fails to take evasive action, the collision avoidance system will automatically provide either braking alone, steering alone, or combined braking and steering.

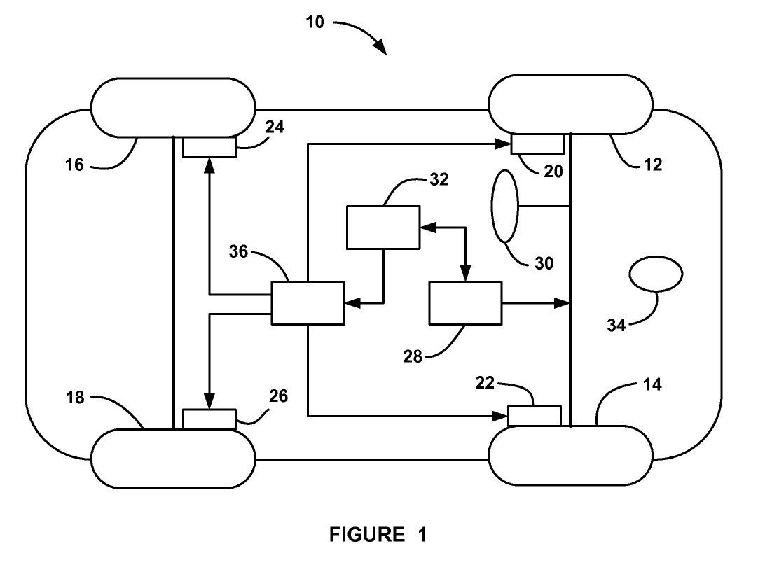

FIG. 1 is a schematic illustration of a vehicle 10 including a left front wheel 12, a right front wheel 14, a left rear wheel 16 and a right rear wheel 18. The left front wheel 12 includes a braking unit 20, the right front wheel 14 includes a braking unit 22, the left rear wheel 16 includes a braking unit 24 and the right rear wheel 18 includes a braking unit 26. The vehicle 10 also includes an automatic steering system 28, such as electronic power steering, active front steering system, etc., that causes the front wheels 12 and 14 to steer along a desired path in response to the vehicle driver controlling a vehicle hand-wheel 30. The vehicle 10 also includes an ECA system 32 that receives various images and signals external to the vehicle 10 from various sensors and cameras that may be on the vehicle 10, such as long-range radar, short-range radar, video cameras, etc, represented collectively as sensor 34. The ECA system 32 provides automatic collision avoidance if an object or other vehicle in front of the vehicle 10 is detected by the sensor 34 consistent with the discussion herein.

As will be discussed in detail below, the ECA system 32 may provide automatic steering of the vehicle 10 using the steering system 28 to avoid a collision with objects or vehicles. In the event that the steering system 28 fails in any manner during the collision avoidance maneuver, the present invention proposes using a differential braking system 36 to provide the steering by selectively providing braking force signals to the braking units 20-26. Differential braking is a well known vehicle stability process where braking control is selectively provided to each of the wheels 12-18 of the vehicle 10 to cause the vehicle 10 to steer in a desirable direction. Differential braking has particular application for vehicle stability control where a desired vehicle steering direction as provided by the vehicle hand-wheel 30 may not be the same as the actual steering direction of the vehicle 10 as determined, for example, by a yaw rate sensor, because the vehicle 10 has lateral slip as a result of various conditions, such as a low coefficient of friction surface.

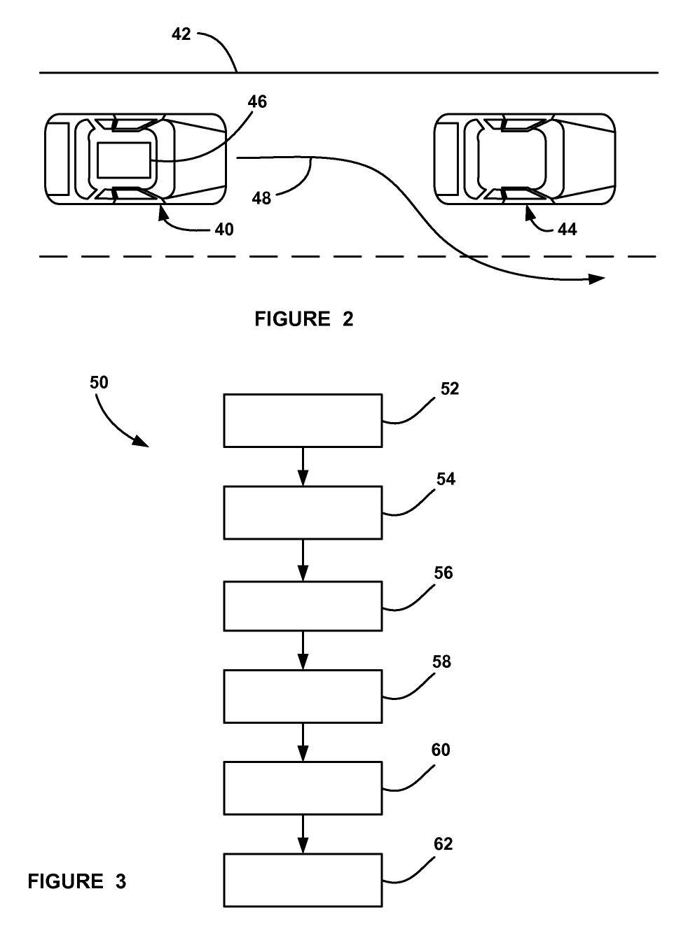

FIG. 2 is an illustration of a host vehicle 40 traveling on a roadway 42 following a target vehicle 44, where the host vehicle 40 includes an ECA system 46 of the type discussed herein. As the host vehicle 40 approaches the target vehicle 44 at a speed where a collision will occur if no control changes are made, the ECA system 46 will give audible warnings to the driver of the host vehicle 40 to take evasive action, and if none are taken, the ECA system 46 may automatically initiate vehicle braking as long as a distance s from the host vehicle 40 to the target vehicle 44 is greater than a calculated braking distance s_{brake}, where braking can be effectively provided to prevent the collision.

If the speed of the host vehicle 40 and the distance s between the host vehicle 40 and the target vehicle 44 becomes too short, the ECA system 46 may then provide automatic steering if the distance s approaches a calculated steering threshold sₛₜₑₑᵣ, where sₛₜₑₑᵣ<s_{brake}. If the distance s between the host vehicle 40 and the target vehicle 44 is so short based on the parameters referred to above, then combined automatic braking and steering may be required. The automatic steering will be provided only if the speed of the host vehicle 40 is above a predetermined speed, V>V*, where V* may be 11 m/sec for high friction roadway surfaces. As will be discussed in detail below, the ECA system 46 determines an optimal path 48 based on various factors, such as the width of the vehicle 44, the coefficient of friction μ of the surface of the roadway 42, etc., that the automatic braking and/or steering will cause the host vehicle 40 to follow to avoid the collision with the target vehicle 44.

U.S. patent application Ser. No. 12/908,689, titled, Optimal Acceleration Profile for Enhanced Collision Avoidance, filed Oct. 20, 2010, assigned to the assignee of this application and herein incorporated by reference, discloses a method for determining the optimal path 48 that the host vehicle 40 will travel along on the roadway 42 to avoid the target vehicle 44 using certain algorithms in the ECA system 46. The '689 method includes providing an optimization look-up table off-line for storing on the host vehicle 40 that includes an optimal vehicle braking or longitudinal deceleration and an optimal distance along the optimal path 48 based on a range of speeds of the host vehicle 40 and the coefficient of friction μ of the roadway surface. The method determines the current speed of the host vehicle 40 and the coefficient of friction μ of the roadway surface on which the host vehicle 40 is traveling during the potential collision, and uses the look-up table to determine the optimal longitudinal deceleration or braking of the host vehicle 40 for the optimal path 48. The method also determines an optimal lateral acceleration or steering of the host vehicle 40 for the optimal path 48 based on a friction ellipse and the optimal braking.

During a collision avoidance maneuver, as discussed herein, where the ECA system 46 may employ automatic braking control, steering control or both, it is possible that the steering system 28 may fail during the maneuver, where normal steering may not be available. Those skilled in the art will readily recognize many suitable techniques for detecting steering failures and the types of failures that may occur. As mentioned, the present invention proposes employing differential braking that selectively provides braking individually to the wheels of the vehicle 40 to cause the vehicle 40 to be steered along the optimal path 48 that has been determined for the particular collision avoidance maneuver.

As the host vehicle 40 is traveling along the optimal path 48 relative to the target vehicle 44 during the collision avoidance maneuver, and a steering failure has been detected, a model prediction control (MPC) algorithm in the ECA system 46 will minimize a cost function J based on changes to a braking control command u, for example, selectively provided to the braking units 20-26, so that the actual or predicted path of the host vehicle 40 follows the desired optimal path 48. Equation (1) below defines the cost function J that is minimized based on changes to the braking control command u, where a positive braking control command+u identifies braking on one side of the vehicle 40 and a negative braking control command−u identifies braking on the other side of the vehicle 40.

When the MPC algorithm is determining the optimal path 48, each position of the host vehicle 40 along the path 48 is defined by a lateral position y of the vehicle 40 and a heading angle φ of the vehicle 40. The cost function J gives a deviation of the orientation of the host vehicle 40 at incremental points j in the future relative to a horizon ΔT based on a difference between the position of the host vehicle 40 and the optimal path 48 at those points. For example, the value ΔT is a control horizon that defines how far into the future the control will be calculated to minimize the cost function J, which may be, for example, one second. The cost function J is based on an error of the lateral position y of the vehicle 40 and an error of the heading angle φ of the vehicle 40. The deviation between the lateral offset error yₑᵣᵣ and heading angle error φₑᵣᵣ is minimized by the cost function J using the braking control command u.

As mentioned, the sign of the braking control command u determines which side of the vehicle 40 the braking is provided, where only one side braking is provided at any point in time. The front-to-rear proportion braking between the front and rear wheels is then determined based on other factors, such as vehicle center of gravity, load, etc.

J=∫₀^{ΔT}{[yφ]ₑᵣᵣ·Q(x)·[_{φ}^{y}]ₑᵣᵣ+u·R(t)·u}dt (1)

Where yₑᵣᵣ is the lateral offset error (y_{desired}−y_{predicted}), φₑᵣᵣ is the heading angle error (φ_{desired}−φ_{predicted}), and Q(x) and R(t) are weighting factors.

The continuous braking control command u is converted to a discrete (k) braking force command uₖ by equation (2).

$${u}_{k} = - \frac{{\sum }_{j = 1}^{p} [ {\sum }_{i = 1}^{j} {( {CA}^{i - 1} B )}^{T} {R}_{k + j} {CA}^{j} ]}{{\sum }_{j = 1}^{p} [ {\sum }_{i = 1}^{j} {( {CA}^{i - 1} B )}^{T} {R}_{k + j} ( {CA}^{i - 1} B ) ] + {Q}_{k}} {x}_{k} + \frac{{\sum }_{j = 1}^{p} [ {\sum }_{i = 1}^{j} {( {CA}^{i - 1} B )}^{T} {R}_{k + j} ( {r}_{k + j} - C {\sum }_{i = 1}^{j} {A}^{i - 1} {h}_{k} ) ]}{{\sum }_{j = 1}^{p} [ {\sum }_{i = 1}^{j} {( {CA}^{i - 1} B )}^{T} {R}_{k + j} ( {CA}^{i - 1} B ) ] + {Q}_{k}} \qquad ( 2 )$$

Where R is a weight on control, Q is a weight on tracking error, and A, B and C are matrices that define the linear discrete motion of the vehicle 40 as follows.

$$\begin{matrix}\dot{y} = {V}_{y} + {V}_{x} ϕ & ( 3 ) \\ \dot{ϕ} = {V}_{y} y - {V}_{x} ρ & ( 4 ) \\ {\dot{V}}_{y} = \frac{{C}_{f} + {C}_{r}}{{MV}_{x}} {V}_{y} - ( {V}_{x} + \frac{{C}_{f} a - {C}_{r} b}{{MV}_{x}} ) r + \frac{{C}_{f}}{M} δ & ( 5 ) \\ \dot{r} = - \frac{{C}_{f} a - {C}_{r} b}{{I}_{z} {V}_{x}} {V}_{y} - \frac{{a}^{2} {C}_{f} + {b}^{2} {C}_{r}}{{I}_{z} {V}_{x}} + \frac{{aC}_{f}}{{I}_{z}} δ + \frac{T}{2 {I}_{z}} u & ( 6 )\end{matrix}$$

Where the force command uₖ is distributed to each wheel as:

u=Fₓ^{LR}+Fₓ^{LF}−Fₓ^{RR}−Fₓ^{RF} (7)

And where F^{xx} is the braking force on a particular wheel of the vehicle, namely, left-rear (LR), left-front (LF), right-rear (RR) and right-front (RF), Fₓ is the longitudinal force, y is the vehicle center of gravity (CG) lateral deviation from the center of the lane (defined by the measured lane marking offsets), φ is the heading angle error, V_{y} is the vehicle lateral velocity, r is the vehicle yaw rate, δ is the road wheel angle (=0), a and b are the longitudinal distances from the vehicle center of gravity to front and rear axles, respectively, T is vehicle track, M is vehicle mass, I_{z} is vehicle yaw moment of inertia, C_{f} and Cᵣ are front and rear cornering stiffness, respectively, ρ is the road curvature, and hₖ is the discrete version of the following continuous matrix h=[0,−ρVx,0,0]^{T}.

Equations (3)-(6) can be written as state space expressions as follows.

\dot{x}=Ax+Bu+h (8)

xₖ₊₁=Axₖ+Buₖ+hₖ (9)

y=Cx (10)

Yₖ=Cxₖ (11)

Where x is the state vector consisting of lateral offset, heading angle, lateral velocity and yaw rate, y is an output vector consisting of lateral offset and heading angle, and A is matrix A(V), where Vₓ is the vehicle longitudinal speed, and where:

$$\begin{matrix}x = {[ y ϕ {v}_{y} r ]}^{T} & ( 12 ) \\ u = δ & ( 13 ) \\ {A}_{c} = [ \begin{matrix}0 & {V}_{x} & 1 & 0 \\ 0 & 0 & 0 & 1 \\ 0 & 0 & - \frac{{C}_{j} + {C}_{r}}{mv} & \frac{{bC}_{r} - {aC}_{f}}{{mv}_{x}} - {v}_{x} \\ 0 & 0 & \frac{{bC}_{r} - {aC}_{f}}{{Iv}_{x}} & - \frac{{a}^{2} {C}_{f} + {b}^{2} {C}_{r}}{{Iv}_{x}}\end{matrix} ] & ( 14 ) \\ {B}_{c} = [ \begin{matrix}0 \\ 0 \\ \frac{{C}_{f}}{m} \\ \frac{{aC}_{f}}{I}\end{matrix} ] & ( 15 ) \\ {C}_{c} = [ \begin{matrix}1 & 0 & 0 & 0 \\ 0 & 1 & 0 & 0\end{matrix} ] & ( 16 ) \\ {A}_{d} = {e}^{{A}_{c} {t}_{s}} & ( 17 ) \\ {B}_{d} = {\int }_{0}^{s} {e}^{{A}_{c} α} {B}_{c} d α & ( 18 )\end{matrix}$$

The amount of differential braking provided to the host vehicle 40 to maintain the vehicle 40 on the optimal path 48 is limited by constraints that are based on wheel slip. Particularly, the amount of braking and/or steering provided during the collision avoidance maneuver should not cause the vehicle 40 to become unstable as a result of slipping on the roadway surface. To maintain this stability, the braking force command uₖ should be maintained within a friction ellipse for optimal lateral acceleration for each prediction point j=1, 2, . . . , p. As is known by those skilled in the art, a friction ellipse for a tire provides an indication of the maximum horizontal force that may be generated for the tire, where the size of the ellipse is dependent on that tire. The vehicle slip angle αⱼ at any prediction point j is defined by matrix P as:

αⱼ=PA^{j-1}xₖ+(PA^{j-2}B+ . . . +PB)uₖ (19)

The slip angle αⱼ in equation (19) is calculated for both the front and rear of the vehicle 10, where:

$$\begin{matrix}{P}_{front} = [ 0 , 0 , - \frac{1}{{V}_{x}} , - \frac{a}{{V}_{x}} ] & ( 20 ) \\ {P}_{rear} = [ 0 , 0 , - \frac{1}{{V}_{x}} , \frac{b}{{V}_{x}} ] & ( 21 )\end{matrix}$$

The combined braking and steering constraint based on the slip angle αⱼ and the particular braking force command uₖ is defined as:

(C_{f}αⱼ)²+uₖ²≦(μW_{f})² (22)

Where W is the normal force at each corner of the vehicle 40.

If the braking force command uₖ determined by equation (2) does not cause the inequality of equation (22) to be satisfied, then the braking force command uₖ is limited as defined by equation (23).

uₖ²=(μW_{f})²−(C_{f}αⱼ)² (23)

FIG. 3 is a flow chart diagram 50 showing a process for providing differential braking based on the braking force command uₖ that has been determined to minimize the cost function J. At box 52, the discrete braking force command uₖ at a particular point in time is determined based on the discussion above. At box 54, the algorithm determines whether it is left side vehicle braking or right side vehicle braking that should be applied to the braking units 20-26 based on whether the braking force command uₖ is greater than zero or less than zero. Once the algorithm determines what side of the vehicle 40 should be braked, the algorithm then proportions the braking between the front wheel and the rear wheel on that side of the vehicle 40 at box 56. This type of front-to-rear proportional braking is typically based on the weight distribution of the vehicle, and can be determined based on known processes for a particular type of vehicle. Once the algorithm determines the braking proportioning between the front and rear wheels on the particular side of the vehicle 40, the algorithm converts the brake force command uₖ to a brake cylinder pressure command at box 58, and determines if that brake cylinder pressure exceeds an ABS limit at box 60. If the pressure does not exceed the ABS limit, then the brake pressure command is provided at box 62.

As will be well understood by those skilled in the art, the several and various steps and processes discussed herein to describe the invention may be referring to operations performed by a computer, a processor, or other electronic calculating device that manipulates and/or transforms data using electrical phenomenon. Those computers and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media.

The foregoing discussion disclosed and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for providing collision avoidance in a host vehicle, said method comprising:
determining that a collision between an object and the host vehicle is imminent;
determining an optimal path for the host vehicle to travel along to avoid the object if the collision is imminent;
providing automatic vehicle steering to cause the host vehicle to follow the optimal path;
determining that the vehicle steering has failed during the automatic vehicle steering; and
causing the host vehicle to steer along the optimal path by using differential braking if the vehicle steering has failed.

2. The method according to claim 1 wherein causing the host vehicle to steer using differential braking includes determining a braking force command that selectively provides braking to wheels on one side of the host vehicle or wheels on an opposite side of the host vehicle.

3. The method according to claim 2 wherein determining a braking force command includes calculating the braking force command based on linear motion of the vehicle and state space equations.

4. The method according to claim 2 wherein determining the braking force command includes determining whether the braking force command will cause wheel slip to occur based on a coefficient of friction of road surface and a weight of the host vehicle.

5. The method according to claim 4 wherein the braking force command is set to a predetermined maximum braking force command that prevents wheel slip if the determined braking force command would cause wheel slip to occur.

6. The method according to claim 2 wherein selectively providing the braking force command to the vehicle includes proportioning the braking to front and rear wheels on the particular side of the host vehicle based on loading of the vehicle.

7. The method according to claim 1 wherein causing the vehicle to steer using differential braking includes minimizing a cost function that identifies a relationship between a vehicle lateral offset error defined by a desired lateral offset along the optimal path and a predicted lateral offset and a vehicle heading angle error defined by a desired heading angle along the optimal path and a predicted heading angle.

8. The method according to claim 7 wherein minimizing the cost function includes using the equation:
$$J = {\int }_{0}^{Δ T} \{ {[ y ϕ ]}_{err} \cdot Q ( x ) \cdot {[ \begin{matrix}y \\ ϕ\end{matrix} ]}_{err} + u \cdot R ( t ) \cdot u \} d t$$
where yₑᵣᵣ is the lateral offset error, φₑᵣᵣ is the heading angle error, and Q(x) and R(t) are weighting factors.

9. The method according to claim 2 wherein determining the braking force command includes converting a continuous braking force command to a discrete braking force command using the equation:
$${u}_{k} = - \frac{{\sum }_{j = 1}^{p} [ {\sum }_{i = 1}^{j} {( {CA}^{i - 1} B )}^{T} {R}_{k + j} {CA}^{j} ]}{{\sum }_{j = 1}^{p} [ {\sum }_{i = 1}^{j} {( {CA}^{i - 1} B )}^{T} {R}_{k + j} ( {CA}^{i - 1} B ) ] + {Q}_{k}} {x}_{k} + \frac{{\sum }_{j = 1}^{p} [ {\sum }_{i = 1}^{j} {( {CA}^{i - 1} B )}^{T} {R}_{k + j} ( {r}_{k + j} - C {\sum }_{i = 1}^{j} {A}^{i - 1} {h}_{k} ) ]}{{\sum }_{j = 1}^{p} [ {\sum }_{i = 1}^{j} {( {CA}^{i - 1} B )}^{T} {R}_{k + j} ( {CA}^{i - 1} B ) ] + {Q}_{k}}$$
where R is a weight on control, Q is a weight on tracking error, and A, B and C are matrices that define the linear discrete motion of the vehicle.

10. The method according to claim 1 wherein the object is a target vehicle in front of the host vehicle.

11. A method for providing collision avoidance between a host vehicle and a target vehicle traveling in front of the host vehicle on a roadway, said method comprising:
determining that a collision between the target vehicle and the host vehicle is imminent;
determining a desired optimal path for the host vehicle to travel along to avoid colliding with the target vehicle if the collision is imminent; and
providing automatic vehicle steering if necessary to cause the host vehicle to follow the optimal path where the automatic vehicle steering is provided using differential braking by determining a braking force command that selectively provides braking to wheels on one side of the host vehicle or wheels on an opposite side of the host vehicle.

12. The method according to claim 11 further comprising determining that normal vehicle steering has failed before using differential braking to steer the vehicle on the path.

13. The method according to claim 11 wherein determining the braking force command includes determining whether the braking force command will cause wheel slip to occur based on a coefficient of friction of road surface and a weight of the host vehicle.

14. The method according to claim 13 wherein the braking force command is set to a predetermined maximum braking force command that prevents wheel slip if the determined braking force command would cause wheel slip to occur.

15. The method according to claim 11 wherein selectively providing the braking force command to the vehicle includes proportioning the braking to front and rear wheels on the particular side of the host vehicle based on loading of the vehicle.

16. The method according to claim 11 wherein using differential braking includes minimizing a cost function that identifies a relationship between a vehicle lateral offset error defined by a desired lateral offset along the optimal path and a predicted lateral offset and a vehicle heading angle error defined by a desired heading angle along the optimal path and a predicted heading angle.

17. A collision avoidance system on a host vehicle, said system comprising:
means for determining that a collision between an object and the host vehicle is imminent;
means for determining an optimal path for the host vehicle to travel along to avoid the object if the collision is imminent;
means for providing automatic vehicle steering to cause the host vehicle to follow the optimal path;
means for determining that the vehicle steering has failed during the automatic vehicle steering; and
means for causing the host vehicle to steer along the optimal path using differential braking if the vehicle steering has failed.

18. The system according to claim 17 wherein the means for causing the host vehicle to steer determines a braking force command that selectively provides braking to wheels on one side of the host vehicle or wheels on an opposite side of the host vehicle.

19. The system according to claim 17 wherein the means for determining the braking force command determines whether the braking force command well cause wheel slip to occur, and if so, setting the braking force command to a maximum braking force command that does not cause wheel slip to occur.

20. The system according to claim 17 wherein the means for causing the host vehicle to steer minimizes a cost function that identifies a relationship between a vehicle lateral offset error defined by a desire to lateral offset along the optimal path and a predicted lateral offset and a vehicle heading angle error defined by a desired heading angle along the optimal path in a predicted heading angle.
